(19) United States
(12) Patent Application Publication
(10) Pub. No.: US 2009/0305155 A1
(43) Pub. Date: Dec. 10, 2009

(54) ELECTROPHOTOGRAPHIC PHOTORECEPTOR AND IMAGE FORMING APPARATUS PROVIDED WITH THE SAME

(76) Inventors: Takatsugu OBATA, Osaka (JP); Akihiro KONDOH, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/478,150

(22) Filed: Jun. 4, 2009

(30) Foreign Application Priority Data
Jun. 6, 2008 (JP) 2008-149308

(51) Int. Cl. G03G 5/047; G03G 15/00

(52) U.S. Cl. 430/58.85; 399/159

(57) ABSTRACT

A electrophotographic photoreceptor comprising a monolayered photosensitive layer containing a charge generation material and a charge transport material or a multilayered photosensitive layer obtained by laying a charge generation layer containing a charge generation material and a charge transport layer containing a charge transport material in this order or in reverse order, on a conductive support, wherein the monolayered photosensitive layer or the charge transport layer of the multilayered photosensitive layer contains, as the charge transport material, an enamine compound represented by the formula (I):

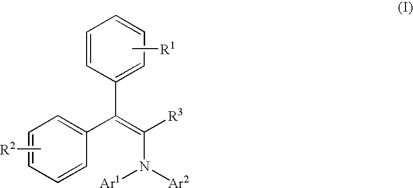

wherein Ar¹ and Ar², which may be the same or different, respectively represent an aryl group which may have a substituent or a monovalent heterocyclic residue which may have a substituent; R¹ and R², which may be the same or different, respectively represent a hydrogen atom, a halogen atom, an alkyl group which may have a substituent or an alkoxy group which may have a substituent; and R³ represents a hydrogen atom or an alkyl group which may have a substituent), and has photosensitive properties in light of wavelength range from 390 to 500 nm.

### CROSS-REFERENCE TO RELATED APPLICATIONS

This application is related to Japanese Patent Application No. 2008-149308 filed on Jun. 6, 2008 whose priority is claimed under 35 USC §119, the disclosure of which is incorporated by reference in its entirety.

### BACKGROUND OF THE INVENTION

1. Field of the Invention

The present invention relates to an electrophotographic photoreceptor which is suitably used for an image forming apparatus using a semiconductor laser oscillating at a short wavelength as an exposure light source and can realize high resolution, and to an image forming apparatus provided with the electrophotographic photoreceptor.

2. Description of the Related Art

The electrophotographic photoreceptor (hereinafter also referred to as “photoreceptor”) used in an electrophotographic system image forming apparatus (also referred to as “electrophotographic device”) which are used as many digital complex devices, printers and the like is formed by laying photosensitive layers containing photoconductive materials on a conductive support, and inorganic photoconductive materials such as selenium have been used as the photoconductive material.

Organic photoconductive materials, on the other hand, are slightly inferior to inorganic photoconductive materials in sensitivity, durability and environmental stability. However, these organic photoconductive materials have been recently developed from the viewpoint of toxicity, production costs and the degree of freedom of material design and are therefore widely used.

At present, as the photoreceptor (organic photoreceptor) using organic photoconductive materials, function separation type photoreceptors are usually in practical use in which a charge generation function and a charge transport function are assigned to separate materials (charge generation material and charge transport material).

Such function separation type photoreceptor has the advantage that the range of selection of each material is wide and therefore, materials having the best photographic characteristics such as charge characteristics, photosensitive wavelength range, sensitivity, residual potential, repetitive characteristics and printing durability may be combined to provide a high performance photoreceptor.

Also, these organic photoreceptors have the advantage that inexpensive photoreceptors having extremely high productivity can be provided because the photosensitive layer can be formed on a conductive support by coating.

Furthermore, when a binder resin is contained in a charge transport layer, a photoreceptor superior in abrasive resistance can be designed by appropriately selecting the binder resin.

In the meantime, an image forming apparatus using an organic photoreceptor is demanded to output a highly accurate digital image in response to an expansion of demand as image output terminals used in current printers.

As the exposure light source which cope with such a digital recording system, for example, many semiconductor lasers or light-emitting diodes which are small-sized, inexpensive and highly reliable are used.

An oscillation wavelength of a semiconductor laser most used currently is in the near-infrared region, that is, in the vicinity of 780 to 800 nm and an oscillation wavelength of a typical light-emitting diode is 740 nm.

In recent years, ultraviolet to blue short wavelength lasers (blue semiconductor laser) with an oscillation wavelength of 400 to 500 nm have been developed as the exposure light source which copes with the digital recording system and are commercially available at this time.

To cope with this situation, a multilayered photoreceptor has been developed, which has a charge generation layer containing an organic compound (particularly, a phthalocyanine pigment) which absorbs light with a long-wavelength range to exhibit sensitivity have been developed for an image forming apparatus provided with a laser as the exposure light source.

In the meantime, studies for an improvement in the resolution of image quality have been recently made in order to improve the image quality of the image output from the image forming apparatus.

Example of a method to attain an image improved in recording density and resolution includes an optical method in which a diameter of a spot of a laser beam is limited, to thereby improve writing density. A method for limiting the diameter of the spot of the laser beam can include reducing the focal distance of lens to be used. However, it has found that it is difficult to design the optical system so that a laser with an oscillation wavelength near to 800 nm in the near-infrared region has a difficulty in obtaining the distinctness of the outline of the spot even if the diameter of the beam is narrowed by the operation of the optical system. This is caused by the diffraction limit of laser light and is an unavoidable phenomenon.

Generally, a spot diameter D of laser light (laser beam) converged on the surface of the photoreceptor is represented by the following equation, wherein the wavelength of the laser beam (oscillation wavelength of the laser light) is λ and the numerical aperture of the lens is NA.

D=1.22λ/NA

According to this equation, the spot diameter D is proportional to the oscillation wavelength of the laser light and therefore, it is understood that it is only required to use a laser having a short oscillation wavelength to reduce the spot diameter D.

In other words, it is understood that an image quality having higher resolution can be attained if a short-wavelength laser is used in place of a near-infrared semiconductor laser which is currently mainly used.

The development of a laser with a short oscillation wavelength is behind as compared to that of a laser having a long oscillation wavelength. However, a reel laser with an oscillation wavelength near to 650 nm was in practical use at the beginning of 1990s, followed by a success in developing a bluish ultraviolet laser with an oscillation wavelength of 410 nm in 1995, the bluish ultraviolet laser being produced as the light source for a blue ray disk on a commercial basis.

A blue color type laser such as a bluish ultraviolet laser is greatly expected to improve a recording density of an optical disk. However, conventional photoreceptors have no sensitivity in that wavelength range and have been therefore scarcely expected as the exposure light source for the image forming apparatus.

If a charge generation material which absorbs light even at a wavelength of 500 nm or less is used in a general multilayered photoreceptor which has been in practical use, that is, a photoreceptor obtained by laying a charge generation layer and a charge transport layer in this order on a conductive support, the photoreceptor will generally have sensitivity to exposure light of a short-wavelength laser having a wavelength of 500 nm or less. However, in actual, the charge transport layer absorbs light with a wavelength of 500 nm or less and therefore, the exposure light of the shot-wavelength laser used as the exposure light source is absorbed before it reaches the charge generation layer, with the result that the multilayered photoreceptor has no sensitivity in such wavelength range.

For example, Takatsugu Obata, and four others, “Prediction of physical properties of a hole transport material using computer chemistry”, Sharp Technical Report, April, 2000, No. 76, p. 36-40, discloses a hole transport material transporting holes being one of charges.

Since the photoreceptor is exposed by highly intensive light with even wavelength components in a short-wavelength range, there rises a problem that when the photoreceptor is used for a long term, the charge transport material and the charge generation material are easily denatured and also, oxide products generated by the reaction of a nitrogen oxide and an antioxidant are colored to lead to a reduction in light transmittance, so that sufficient exposure is riot performed, which results in that the photoreceptor is outstandingly deteriorated in sensitivity and therefore high image qualities cannot be maintained.

### SUMMARY OF THE INVENTION

Accordingly, the present invention provides a electrophotographic photoreceptor comprising a monolayered photosensitive layer containing a charge generation material and a charge transport material or a multilayered photosensitive layer obtained by laying a charge generation layer containing a charge generation material and a charge transport layer containing a charge transport material in this order or in reverse order, on a conductive support, wherein the monolayered photosensitive layer or the charge transport layer of the multilayered photosensitive layer contains, as the charge transport material, an enamine compound represented by the formula (I):

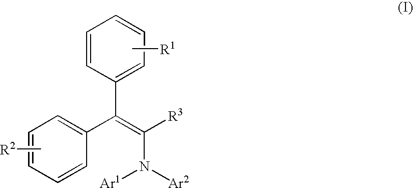

(wherein Ar¹ and Ar₂, which may be the same or different, respectively represent an aryl group which may have a substituent or a monovalent heterocyclic residue which may have a substituent; R¹ and R², which may be the same or different, respectively represent a hydrogen atom, a halogen atom, an alkyl group which may have a substituent or an alkoxy group which may have a substituent; and R³ represents a hydrogen atom or an alkyl group which may have a substituent), and has photosensitive properties in light of wavelength range from 390 to 500 nm.

The present invention also provides an image forming apparatus comprising the electrophotographic photoreceptor as mentioned above, a charging means for charging the electrophotographic photoreceptor, an exposure means for exposing the charged electrophotographic photoreceptor by using a semiconductor laser with an oscillation wavelength of 390 to 500 nm as an exposure light source to form an electrostatic latent image, a developing means for developing the electrostatic latent image formed by the exposure to form a toner image, a transfer means for transfer the developed toner image to a recording material, a fixing means for fixing the transferred toner image to the recording material to form an image, and a cleaning means for removing and recovering a toner left on the electrophotographic photoreceptor.

### BRIEF DESCRIPTION OF THE DRAWINGS

FIG. 1 is a schematic sectional view showing a structure of an essential part of a photoreceptor according to the present invention;

FIG. 2 is a schematic sectional view showing a structure of an essential part of a photoreceptor according to the present invention;

FIG. 3 is a schematic sectional view showing a structure of an essential part of a photoreceptor according to the present invention; and

FIG. 4 is a schematic side view showing a structure of an image forming apparatus according to the present invention.

### DETAILED DESCRIPTION OF THE INVENTION

It is an object of the present invention to provide a photoreceptor which has highly sensitive characteristics in a wavelength range from 390 to 500 nm, is free from fatigue deterioration caused by light, and has high durability, and an image formation means provided with the photoreceptor and an exposure means which forms an electrostatic latent image by exposure using a semiconductor laser with an oscillation wavelength of 390 to 500 nm as an exposure light source.

The inventors of the present invention have found that the object can be solved by adding an enamine compound having a specific structure in a monolayered photosensitive layer or a charge transport layer of a multilayered photosensitive layer, to complete the present invention.

The photoreceptor of the present invention relates to a photoreceptor formed by laying at least a monolayered photosensitive layer containing a charge generation material and a charge transport material or a multilayered photosensitive layer in which a charge generation layer containing a charge generation material and a charge transport layer containing a charge transport material are layered in this order or in reverse order, on a conductive support, wherein the monolayered photosensitive layer or the charge transport layer of the multilayered photosensitive layer contains, as the charge transport material, an enamine compound represented by the formula (I) and and has photosensitive properties in light of wavelength range from 390 to 500 nm.

The present invention can provide a photoreceptor which has highly sensitive characteristics in a wavelength range from 390 to 500 nm, is free from fatigue deterioration caused by light, and has high durability, and an image forming apparatus containing the photoreceptor and an exposure means which forms an electrostatic latent image by exposure using a semiconductor laser with an oscillation wavelength of 390 to 500 nm as an exposure light source.

This reason is inferred to be that the enamine compound represented by the formula (I) in the present invention has higher mobility than a triarylamine derivative which is a typical charge transport material that does not absorb light with a wavelength range from 390 to 500 nm because it does not absorb light with a wavelength range from 390 to 500 nm and has four conjugate units which are the hopping sites of holes (“S” parameter in Takatsugu Obata, and four others, “Prediction of physical properties of a hole transport, material using computer chemistry”, Sharp Technical Report, April, 2000, No. 76, p. 36-40).

Each substituent in the formula (I) will be explained.

Examples of the aryl group which may have a substituent and represented by Ar¹ or Ar² include aryl groups which may be substituted with an alkyl group having 1 to 4 carbon atoms, an alkoxy group having 1 to 4 carbon atoms or a halogen atom.

Specific examples thereof include a phenyl group, an m-tolyl group, a p-tolyl group, a 2,4-xylyl group, a p-cumenyl group, a 3-trifluoromethylphenyl group, a 4-methoxyphenyl group, a 4-fluorophenyl group, a 2-methyl-4-methoxyphenyl group, a 4-biphenylyl group, a 1-naphthyl group, a 2-naphthyl group and a pyrenyl group. Among them, a phenyl group, a p-tolyl group, a 2,4-xylyl group and a 4-biphenylyl group are particularly preferable.

Examples of the monovalent heterocyclic residue which may have a substituent and represented by Ar¹ or Ar² include monovalent heterocyclic residues which may be substituted with an alkyl group having 1 to 4 carbon atoms.

Specific examples thereof include a 3-furyl group, a 2-thienyl group, a 4-pyridyl group, a 5-benzofuryl group, a 5-benzothiophenyl group and a 5-benzothiazolyl group. Among them, a 2-thienyl group, a 4-pyridyl group and a 5-benzofuryl group are particularly preferable.

Examples of the substituents other than the above in the aryl group and monovalent heterocyclic group include an alkyl group having 1 to 4 carbon atoms (may be further substituted with one or more halogen atoms or an alkoxy group having 1 to 4 carbon atoms), an alkoxy group having 1 to 4 carbon atoms (may be further substituted with one or more halogen atoms or an alkyl group having 1 to 4 carbon atoms), halogen atoms (preferably a fluorine atom), a phenoxy group and a phenylthio group.

Examples of the halogen atom of R¹ or R² include a fluorine atom, a chlorine atom, a bromine atom and an iodine atom. Among them, a fluorine atom is particularly preferable.

Examples of the alkyl group which may have a substituent and represented by R¹, R² or R³ include a methyl group, an ethyl group, a propyl group, an isopropyl group and a trifluoromethyl group.

Examples of the alkoxy group which may have a substituent and represented by R¹ or R² include a methoxy group, an ethoxy group and an isopropoxy group.

As R¹ or R², a hydrogen atom, a fluorine atom, a methyl group, a methoxy group and a trifluoromethyl group are particularly preferable,

As R³, a hydrogen atom and a methyl group are particularly preferable.

In the formula (I), it is preferable that Ar¹ and Ar², which may be the same or different, be respectively an aryl group which may have a substituent, R¹ or R², which may be the same or different, be respectively a hydrogen atom or an alkyl group which may have a substituent, and R³ be a hydrogen atom.

Specific examples of the enamine compound of the present invention may include, but not limited, the following exemplified compounds 1 to 20.

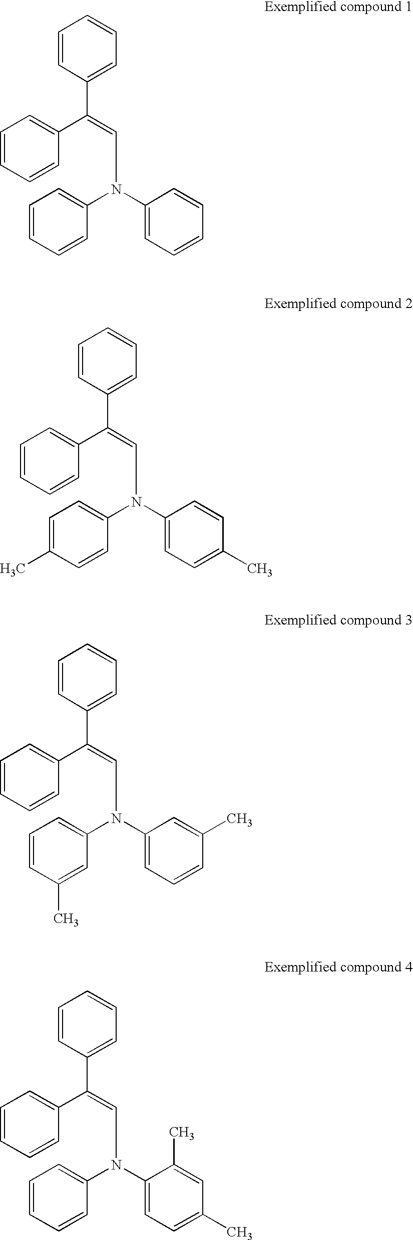

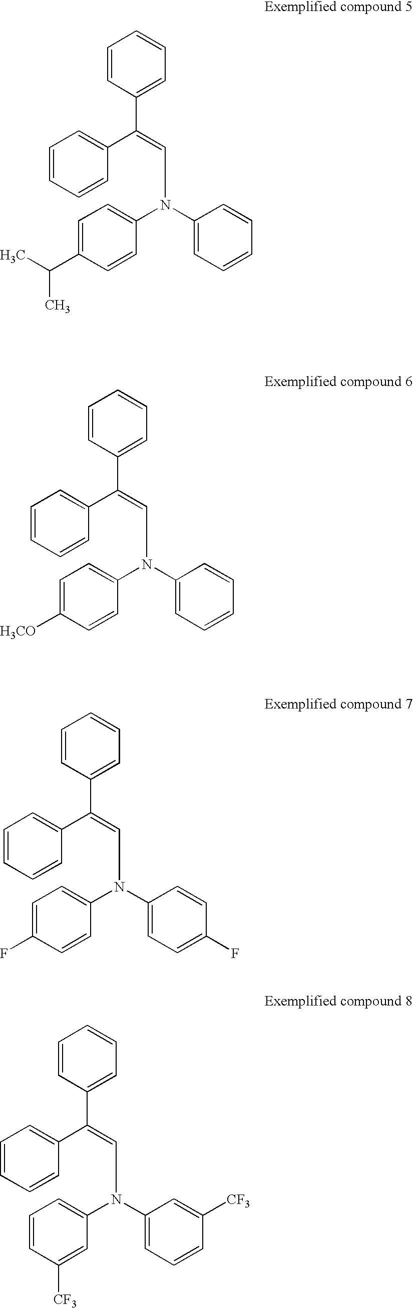

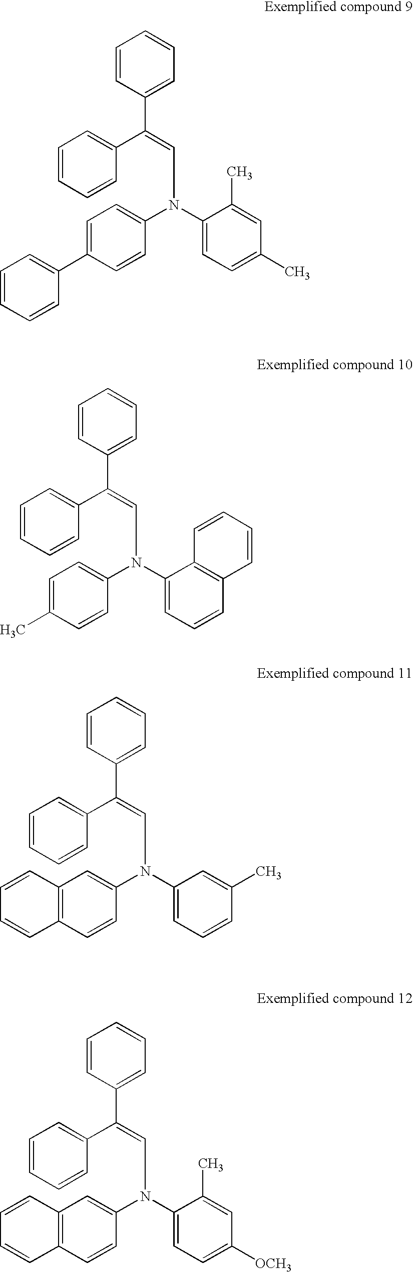

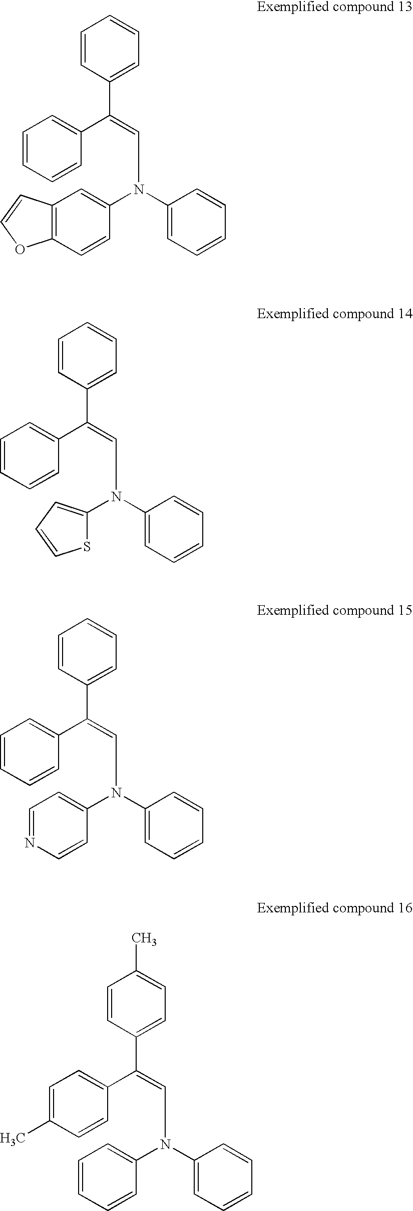

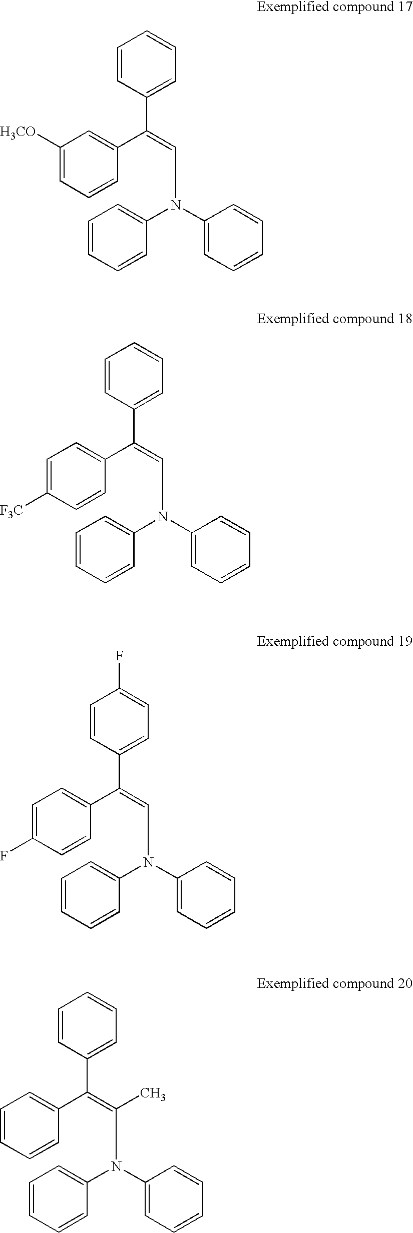

Among these enamine compounds, N,N-(diphenyl)-2,2-diphenylvinylamine (Exemplified compound 1), N,N-(di-p-tolyl)-2,2-diphenylvinylamine (Exemplified compound 2), N-(4-biphenylyl)-N-(2,4-xylyl)-2,2-diphenylvinylamine (Exemplified compound 9) and N,N-(diphenyl)-2,2-di-p-toylvinylamine (Exemplified compound 16) are preferable and Exemplified compound 1 is particularly preferable.

The enamine compound represented by the formula (I) may be produced, for example, in the following manner.

Specifically, a secondary amine compound represented by the formula (II):

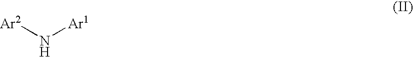

(wherein Ar¹ and Ar² have the same meanings as in the formula (I)) and a diphenylacetaldehyde compound represented by the formula (III):

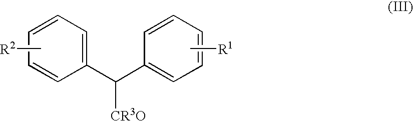

(wherein R¹, R² and R³ have the same meanings as in the formula (I)) are subjected to a dehydration condensation reaction in a solvent to produce the enamine compound represented by the formula (I).

This reaction is performed by heating the diphenylacetaldehyde represented by the formula (III) and an equivalent mol of the secondary amine compound represented by the formula (II) in a solvent in a presence of a catalyst.

Examples of the solvent to be used in the reaction include solvents such as non-polar solvents, alcohols, ethers and ketones, for example, toluene, xylene, chlorobenzene, butanol, diethylene glycol dimethyl ether, and methyl isobutyl ketone.

The amount of the solvent to be used is not particularly limited, and may be appropriately set to be one enough to progress the reaction smoothly according to the reaction conditions such as the amount of the reaction substrate, reaction temperature and reaction time.

Examples of the catalyst to be used in the reaction include acid catalysts such as p-toluenesulfonic acid, camphor sulfonic acid and pyridinium-toluenesulfonic acid.

The amount of the acid catalyst to be used is 1/10 to 1/1000 mol equivalents, preferably 1/25 to 1/500 mol equivalents and more preferably 1/50 to 1/200 mol equivalents based on that of the diphenylacetaldehyde and secondary amine compound which are starting materials.

Since the water generated as a byproduct in the reaction, hinders the progress of the reaction, the condensation reaction is performed in a reactor provided with a Dean-Stark which heats the reaction system to the boiling point of the used solvent or higher temperature to remove the generated water together with the solvent by azeotropic distillation, making possible to produce the enamine compound (I) with high yield. In order to remove the generated water, a water adsorbent such as a molecular sieve may be added to the reaction system to perform a condensation reaction.

The photoreceptor of the present invention will be explained in detail with reference to the drawings.

FIGS. 1 to 3 are schematic sectional views showing a structure of an essential part of the photoreceptor of the present invention.

FIG. 1 is a schematic sectional view showing a structure of an essential part of a multilayered photoreceptor provided with a multilayered photosensitive layer (also referred to as “function separation type photosensitive layer”) formed by laying a charge generation layer and a charge transport layer in this order.

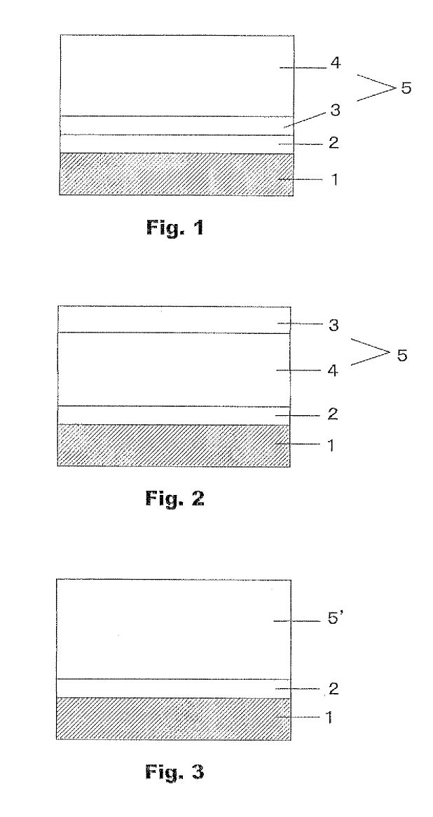

FIG. 2 is a schematic sectional view showing a structure of an essential part of a multilayered photoreceptor provided with a reverse double layer type multilayered photosensitive layer formed by laying a charge transport layer and a charge generation layer in this order.

FIG. 3 is a schematic sectional view showing a structure of an essential part of a monolayered photoreceptor provided with a monolayered photosensitive layer.

Any of the multilayered photosensitive layers shown in FIGS. 1 and 2 may be used. However, the multilayered photosensitive layer of FIG. 1 is preferable.

In the photoreceptor of FIG. 1, an undercoat layer (intermediate layer) 2 described later, and a multilayered photosensitive layer 5 in which a charge generation layer 3 containing a charge generation material and a charge transport layer 4 containing a charge transport material are layered in this order are formed in this order on a surface of a conductive support 1.

In the photoreceptor of FIG. 2, an undercoat layer (intermediate layer) 2 described later, and a reverse double layer type multilayered photosensitive layer 5 in which a charge transport layer 4 containing a charge transport material and a charge generation layer 3 containing a charge generation material are layered in this order are formed in this order on a surface of a conductive support 1.

In the photoreceptor of FIG. 3, an undercoat layer (intermediate layer) 2 described later, and a monolayered photosensitive layer 5′ containing a charge generation material and a charge transport material are formed on a surface of a conductive support 1.

### (Conductive Support 1)

The conductive substrate 1 functions as the electrode of the photoreceptor and also as a support member for each layer.

The constituent material for the conductive support is not particularly limited insofar as it is used in the relevant art.

Specific examples of the constituent material include metal and alloy materials such as aluminum, aluminum alloys, copper, brass, zinc, nickel, stainless steel, chromium, molybdenum, vanadium, indium, titanium, gold and platinum; and materials obtained by laying a metal foil, depositing a metal material or alloy material, or depositing or applying a layer of a conductive compound such as a conductive polymer, tin oxide and indium oxide, on a surface of a substrate made of, for example, polymer materials such as a polyethylene terephthalate, polyamide, polyester, polyoxymethylene and polystyrene, hard paper or glass.

Examples of the shape of the conductive support include a sheet form, cylinder form, columnar form or endless belt form (seamless belt).

The surface of the conductive support may be optionally subjected to an anodic oxidation coating treatment, a surface treatment using chemicals or hot water, a coloring treatment, or an irregular reflection treatment such as surface roughing treatment to the extent that the image quality is not adversely affected.

The irregular reflection treatment is particularly effective when the photoreceptor of the present invention is used in an electrophotographic process using a laser as the exposure light source. Specifically, in the electrophotographic process using a laser as the exposure light source, since the wavelengths of laser light are uniform, there is the case where laser light reflected on the surface of the photoreceptor interferes with the light reflected inside of the photoreceptor, resulting in appearance of interference fringes on an image, and occurrence of image defects. In this respect, the image defects caused by the interference of laser light with uniform wavelengths can be prevented from occurring by the surface of the conductive support being subjected to the irregular reflection treatment.

### (Multilayered Photosensitive Layer 5)

The multilayered photosensitive layer 5 is composed of the charge generation layer 3 and the charge transport layer 4. An optimum material constituting each layer can be independently selected by assigning a charge generation function and a charge transport function to separate layers.

In the following explanations, the multilayered photosensitive layer (FIG. 2) formed by laying the charge generation layer and the charge transport layer in this order will be explained. However, the multilayered photosensitive layer of reverse double layer type (FIG. 3) is essentially similar to that in FIG. 2 except that only the laying order is different from each other.

### (Charge Generation Layer 3)

The charge generation layer 3 contains, as its major component, the charge generation material having the charge generation ability of absorbing the applied light to generate charges and also optionally contains known additives and a binder resin (binding agent).

As the charge generation material, compounds used in the relevant art may be used.

Specific examples of the charge generation material include organic pigments or dyes such as azo type pigments (for example, monoazo type pigments, bisazo type pigments and trisazo type pigments having a carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton or distyrylcarbazole skeleton), perylene type pigments (for example, peryleneimide and perylenic acid anhydride), polycyclic quinone type pigments (for example, quinacridone, anthraquinone and pyrene quinone), phthalocyanine type pigments (for example, metal phthalocyanine, metal-free phthalocyanine and metal-free phthalocyanine halide), indigo type pigments (for example, indigo and thioindigo), squalilium dyes, azulenium dyes, thiopyrylium dyes, pyrylium salts and triphenylmethane type dyes, and inorganic materials such as selenium and amorphous silicon. These charge generation materials may be either singly or in combinations of two or more.

Among these charge generation materials, azo type pigments, perylene type pigments and polycyclic quinone type pigments have highly sensitive characteristics to light with a wavelength range from 390 to 500 nm and are therefore preferable.

The charge generation layer may contain one or two or more known additives selected from a chemical sensitizer, optical sensitizer, antioxidant, ultraviolet absorber, dispersion stabilizer, sensitizers, leveling agent, plasticizer, and microparticles of inorganic compounds or organic compounds in an appropriate amount. These additives may be contained in the charge transport layer described later, and in both of the charge generation layer and the charge transport layer.

The chemical sensitizer and optical sensitizer improve the sensitivity of the photoreceptor and suppress a rise in residual potential and fatigue caused by repeat use to thereby improve electric durability.

Examples of the chemical sensitizer include electro attractive materials, for example, acid anhydrides such as succinic acid anhydride, maleic acid anhydride, phthalic acid anhydride and 4-chloronaphthalic acid anhydride; cyano compounds such as tetracyanoethylene and terephthalmaiondinitrile; aldehydes such as 4-nitrobenzaklehyde; anthraquinones such as anthraquinone and 1-nitroanthraquinone; polycyclic or heterocyclic nitrocompounds such as 2,4,7-trinitrofluorenone and 2,4,5,7-tetranitrofluorenone; diphenoquinone compounds, and those obtained by polymerizing these electron attractive materials.

Examples of the optical sensitizer include organic photoconductive compounds such as xanthene type dyes, quinoline type pigments and copper phthalocyanine, triphenylmethane type dyes typified by Methyl Violet, Crystal Violet, Night Blue and Victoria Blue; acridine dyes typified by Erythrocin, Rhodamine B, Rhodamine 3R, Acridine Orange and Flapeocine; thiazine dyes typified by Methylene Blue and Methylene Green; oxazine dyes typified by Capri Blue and Meldola's Blue; cyanine dyes; styryl dyes; pyrylium salt dyes and thiopyrylium salt dyes.

The antioxidant can maintain sensitive stability for a long period of time.

Examples of the antioxidant include phenol type antioxidants, for example, hindered phenol such as 2,6-di-butyl-p-cresol (BHT), amine type antioxidants such as hindered amine, Vitamin E, hydroquinone, paraphenylenediamine and aryl alkanes and their derivatives, organic sulfur type compounds and organic phosphorous compounds. These compounds may be used either singly or in combinations of two or more.

The hindered phenol has been frequently used. However, the use thereof tends to be restricted because the danger of carcinogenic substances besides harmful effects, for example, that oxide products which are causes of coloring are generated by the reaction with oxidizing gas.

Since many of the hindered amines are colored by the reaction with oxidizing gas, the use of these hindered amines is limited.

Coloring in a short-wavelength region in the present invention shows a reduction in transmittance and there is therefore a fear as to an influence on sensitivity. Therefore, the amount of the hindered amine is preferably small.

Specifically, the amount of the antioxidant to be added is preferably 0.1 to 40 parts by weight and more preferably 0.5 to 15 parts by weight based on 100 parts by weight of the charge generation material.

When the amount of the antioxidant to be added is less than 0.1 parts by weight, there is a fear that sufficient effects on improvements in the stability of the coating solution and the durability of the photoreceptor are not obtained. When the amount of the antioxidant to be added exceeds 40 parts by weight, there is a fear that the characteristics of the photoreceptor are adversely affected.

The leveling agent and the plasticizer can improve film-forming characteristics, flexibility and surface smoothness.

Examples of the leveling agent include silicone type leveling agents.

Examples of the plasticizer include dibasic esters such as phthalates, aliphatic acid esters, phosphates, chlorinated paraffin and epoxy type plasticizers.

The micro particles of inorganic compounds or organic compounds can enhance mechanical strength and improve electric characteristics. Examples of these microparticles include microparticles exemplified in the undercoat layer described later.

The charge generation layer may be formed by the known dry method or wet method.

Examples of the dry method include a method in which the charge generation material is vapor-deposited on the surface of the conductive support.

Examples of the wet method include a method in which the charge generation material and optional additives and a binder resin are dissolved or dispersed in a proper solvent to prepare a charge generation layer coating solution, and the coating solution is then applied to the surface of the conductive support 1 or the surface of the undercoat layer 2 formed on the conductive support 1, followed by dried to remove the organic solvent.

The binder resin can improve the mechanical strength and durability of the charge generation layer and the interlayer binding ability, and resins having the binding ability usable in the relevant art may be used as the binder resin.

Specific examples of the binder resin include thermoplastic resins, for example, a polymethylmethacrylate, polystyrene, vinyl type resins such as a polyvinyl chloride, polycarbonate, polyester, polyester carbonate, polysulfone, polyarylate, polyamide, methacrylic resin, acrylic resin, polyether, polyacrylamide and polyphenylene oxide; thermosetting resins such as a phenoxy resin, epoxy resin, silicone resin, polyurethane, phenol resin, alkyd resin, melamine resin, phenoxy resin, polyvinylbutyral and polyvinylformal, partially crosslinked one of these resins, and copolymer resins containing two or more of these constituent units contained in these resins (insulation resins such as a vinyl chloride/vinyl acetate copolymer resin, vinyl chloride/vinyl acetate/maleic acid anhydride copolymer resin and acrylonitrile/styrene copolymer resin). These binder resins may be used either singly or in combinations of two or more.

The compounded ratio of the charge generation material to the binder resin is not particularly limited, but the ratio of the charge generation material is usually about 20 to 80% by weight based on the binder resin.

When the compounded charge generation material is less than 20% by weight, there is a fear that the sensitivity of the photoreceptor is deteriorated.

When the compounded charge generation material exceeds 80% by weight, not only the film strength of the charge generation material is reduced but also the dispersibility of the charge generation material is reduced and there is the case where coarse particles are increased. Thus, surface charges on a part other than the part to be be eliminated by the exposure are reduced and there is a fear as to the occurrence of many image defects and particularly, image fogs called black dot being a phenomenon that toners are stuck to the white background to form fine spots.

Examples of the organic solvent include aromatic hydrocarbons such as benzene, toluene, xylene, mesitylene, tetralin, diphenylmethane, dimethoxybenzene and dichlorobenzene; halogenated hydrocarbons such as dichloromethane, dichloroethane and tetrachloropropane; ethers such as tetrahydrofuran (THE), dioxane, dibenzyl ether, dimethoxymethyl ether and 1,2-dimethoxyethane; ketones such as methyl ethyl ketone, cyclohexanone, acetophenone and isophorone; esters such as methylbenzoate, ethyl acetate and butyl acetate; sulfur-containing solvents such as diphenyl sulfide; fluorine type solvents such as hexafluoroisopropanol; and aprotic polar solvents such as N,N-dimethylformamide and N,N-dimethylacetamide. These solvents may be used either singly or in combinations of two or more. Mixed solvents obtained by adding alcohols, acetonitrile or methyl ethyl, ketone to these solvents may be used. Among these solvents, non-halogen type organic solvents are preferably used in consideration of global environment.

The charge generation material may be pre-milled prior to the dissolution and the dispersion of the constituent materials in a resin solution.

The pre-milling can be performed using a usual milling machine, for example, a ball mill, sand mill, attritor, vibration mill or ultrasonic dispersing machine.

The dissolution or the dispersion of the constituent materials in the resin solution may be performed using a usual dispersing machine such as a paint shaker, ball mill or sand mill. It is herein preferable to design adequate dispersing conditions in order to prevent impurities from generating from the members constituting the container and dispersing machine by abrasion and from being mixed in the coating solution.

Examples of the method of applying the charge generation layer coating solution include the Baker applicator method, bar-coater method, casting method, spin coating method, roll method and blade method in the case of sheets, and spray method, vertical ring method and dip coating method in the case of drums.

The dip coating method is a method in which the conductive support 1 is dipped in a coating vessel filled with a coating solution and then pulled up at a constant speed or a sequentially varied speed to thereby form a layer on the surface of the conductive support 1. This method is relatively simple and is superior in productivity and production cost. Therefore, this method is frequently used in the production of the photoreceptor. In the device used for the dip coating method, a coating solution dispersing machine typified by the ultrasonic generating machine may be installed to stabilize the dispersibility of the coating solution.

The temperature in the step of drying the coating film is properly 50 to 140° C. and more preferably 80 to 130° C., but no particular limitation thereto as long as the used organic solvent can be removed.

When the drying temperature is less than 50° C., there is the case where the drying time is prolonged. When the drying temperature exceeds 140° C., on the other hand, there is a fear that the electric characteristics of the photoreceptor in repeat use are deteriorated and the obtained image is deteriorated.

The temperature condition used in the production of the photosensitive layer is the same as in the production of other layers such as undercoat layer and in other treatments described later.

The film thickness of the charge generation layer is preferably 0.05 to 5 μm and more preferably 0.1 to 1 μm, but not be particularly limited thereto. When the film thickness of the charge generation layer is less than 0.05 μm, there is a fear as to deterioration in light absorption efficiency and hence deterioration in the sensitivity of the photoreceptor. When the film thickness of the charge generation layer exceeds 5 μm on the contrary, the transfer of charges inside of the charge generation layer determines the rate of the process of removing the charges on the surface of the photoreceptor and there is therefore a fear as to deterioration in the sensitivity of the photoreceptor.

### (Charge Transport Layer 4)

The charge transport layer 4 contains the enamine compound represented by the formula (I) as the charge transport material having the ability of accepting the charges generated from the charge generation material and transporting the charges and the binder resin (binding agent) as its major components.

The enamine compound represented by the formula (I) is used as the charge transport material in the present invention. However, other known charge transport materials may be used together to the extent that the effect of the present invention is not impaired, for the purposes of improving the sensitivity and limiting a rise in residual potential and fatigue in repeat use.

Examples of such a charge transport material include electron-donating materials such as a poly-N-vinylcarbazole and its derivatives, poly-v-carbazolylethyl glutamate and its derivatives, pyrene-formaldehyde condensate and its derivatives, polyvinylpyrene, polyvinylphenanthrene, oxazole derivatives, oxadiazole derivatives, imidazole derivatives, 9-(p-diethylaminostyryl)anthracene, 1,1-bis(4-dibenzylaminophenyl)propane, styrylanthracene, styrylpyrazoline, pyrazoline derivatives, phenylhydrazones, hydrazone derivatives, triphenylamine type compounds, tetraphenyldiamine type compounds, triphenylmethane type compounds, stilbene type compounds and azine compounds having a 3-methyl-2-benzothiazoline ring; and electron-accepting materials such as fluorenone derivatives, dibenzothiophene derivatives, indenothiophene derivatives, phenanthrene quinone derivatives, indenopyridine derivatives, thioxanthone derivatives, benzo[c]cinnoline derivatives, phenazine oxide derivatives, tetracyanoethylene, tetracyanoquinodimethane, promanyl, chloranil and benzoquinone. These charge transport materials may be used either singly or in combinations of two or more.

In the photoreceptor of the present invention, the charge transport material preferably has transmittance (has no absorption) for light with an oscillation wavelength of a semiconductor laser to be used, that is, light with a wavelength range from 390 to 500 nm.

Other than the enamine compounds represented by the formula (I) among the charge transport materials, arylamine type and benzidine type compounds are preferable from such viewpoint.

Generally, the ratio by weight of the charge transport material to the binder resin is 1:1. However, because the enamine compound represented by the formula (I) has a higher mobility than known charge transport materials, the ratio of the binder resin can be made higher while keeping high sensitivity. If the ratio of the binder resin is made higher, the printing durability of the charge transport layer is increased and therefore, the durability of the photoreceptor can be improved.

Accordingly, the ratio E/B of the weight E of the enamine compound to the weight B of the binder resin is 10/12 to 10/25 and preferably 10/16 to 10/20.

When the ratio E/B is less than 10/25, the relative ratio of the binder resin to the enamine compound is higher and there is therefore a fear that sufficient sensitivity is not obtained.

On the other hand, when the ratio E/B exceeds 10/12, there is a fear that the printing durability of the charge transport layer and the durability of the photoreceptor are deteriorated.

As the binder resin, one or two or more types of the same binder resins as those contained in the charge generation layer may be used.

Among these resins, resins containing a polycarbonate as the major component, polyarylate resins and polystyrene resins are optically stable, have particularly high compatibility with the diamine compound represented by the formula (I), have a volume resistance of 10¹³ Ω, or more, exhibit high electrical insulation and are also superior in film-forming characteristics and potential characteristics, and are therefore preferable.

In the photoreceptor of the present invention, the binder resin preferably has transmittance (has no absorption) for light with an oscillation wavelength of a semiconductor laser to be used, that is, light with a wavelength range from 350 to 500 nm. The binder resin is particularly preferable also from such viewpoint.

The charge transport layer may optionally contain the same additives as those contained in the charge generation layer to the extent that the effect of the present invention is not impaired.

The charge transport layer 4 may be formed by dissolving or dispersing the enamine compound represented by the formula (I), a binder resin and optional other additives in a proper organic solvent to prepare a charge transport layer coating solution, then applying the coating solution on the surface of the charge generation layer 3, followed by drying to remove the organic solvent. More specifically, for example, the enamine compound and optional other additives are dissolved or dispersed solution prepared by dissolving a binder resin in an organic solvent to prepare a charge transport layer coating solution.

Other steps and conditions thereof are in accordance with those used in the formation of the charge generation layer.

The film thickness of the charge transport layer is, but not be particularly limited, preferably 10 to 60 μm and more preferably 15 to 40 μm. When the film thickness of the charge transport layer is less than 10 μm, there is a fear that the charge retention ability of the photoreceptor is deteriorated, whereas when the film thickness of the charge transport layer exceeds 60 μm, a part of holes cannot be moved to the surface layer during process and the absorption and scattering of the short-wavelength laser are significantly increased in the photosensitive layer, resulting in a reduction in sharpness and a rise in residual potential and there is therefore a fear that significant image deterioration is caused.

(Undercoat Layer (also Referred to as “intermediate Layer”)2)

The photoreceptor of the present invention is preferably provided with the undercoat layer 2 between the conductive support 1 and the monolayered photosensitive layer 5′ or the multilayered photoreceptor 5 (see, for example, FIG. 1 to FIG. 3).

The undercoat layer has a function of preventing charges from being injected into the monolayered photosensitive layer or the multilayered photosensitive layer from the conductive support. In other words, deterioration in the chargeability of the monolayered photosensitive layer or the multilayered photosensitive layer is limited and therefore, a reduction in surface charges on a part other than the parts to be eliminated by the exposure to light is limited, thereby preventing the occurrence of image defects such as fogging. Particularly, the undercoat layer prevents the occurrence of image defects and particularly many image fogs called black dot being a phenomenon that toners are stuck to the white background to form fine spots in the case of forming an image in the reverse developing process.

The undercoat layer with which the surface of the conductive support is coated can reduce the degree of irregularities that are defects of the surface of the conductive support to uniform the surface, enhances the film formation ability of the monolayered photosensitive layer or the multilayered photosensitive layer, and improves the sticking characteristics (adhesion) between the conductive support and the monolayered photosensitive layer or the multilayered photosensitive layer.

The undercoat layer 2 may be formed, for example, by dissolving a resin material in an appropriate solvent to prepare an undercoat layer coating solution and by applying this coating solution on the surface of the conductive support 1, followed by drying to remove the solvent.

Examples of the resin material include natural macromolecular materials such as casein, gelatin, polyvinyl alcohol and ethyl cellulose, besides the same binder resins that are contained in the charge generation layer. These resin materials may be used either singly or in combinations of two or more. Among these resins, polyamide resins are preferable and alcohol-soluble nylon resins are more preferable.

Examples of the alcohol-soluble nylon resins include copolymer nylons obtained by copolymerizing, for example, 6-nylon, 6,6-nylon, 6,10-nylon, 11-nylon or 12-nylon, and resins obtained by chemically denaturing nylon such as N-alkoxymethyl modified nylon and N-alkoxyethyl modified nylon.

Examples of the solvent used to dissolve or disperse the resin material include water, alcohols such as methanol, ethanol and butanol; grimes such as methyl carbitol and butyl carbitol; and mixed solvents obtained by blending two or more of these solvents. Among these solvents, non-halogen type organic solvents are preferably used in consideration of the global atmosphere.

Other processes and conditions thereof are in accordance with those in the formation of the charge generation layer.

The undercoat layer coating solution may contain metal oxide particles.

The metal oxide particles ensure that the volume resistance of the under coat layer can he controlled with ease, the injection of charges into the multilayered photosensitive layer can be more suppressed and also, the electric characteristics of the photoreceptor can be maintained in various circumstances.

Examples of the metal oxide particles include titanium oxide, aluminum oxide, aluminum hydroxide and tin oxide particles.

When the total content of the resin material and the metal oxide particles in the undercoat layer coating solution is C and the content of the solvent is D, the ratio by weight of (C/D) the both is preferably 3/97 to 20/80 and more preferably 5/95 to 15/85.

When the content of the metal oxide particles is F and the content of the resin material is G, the ratio by weight of the both (F/G) is preferably 0/100 to 90/10 and more preferably 40/60 to 80/20.

The film thickness of the undercoat layer is preferably 0.01 to 10 μm and more preferably 0.1 to 10 μm, but not be particularly limited thereto.

When the film thickness of the undercoat layer is less than 0.01 μm, the resulting undercoat layer does not substantially play its role and there is a fear that a uniform surface cannot be achieved by covering the defects of the conductive support, and there is therefore a fear that the injection of charges from the conductive support into the photosensitive layer cannot be prevented. Whereas when the film thickness of the undercoat layer exceeds 10 μm, it is difficult to form a uniform undercoat layer and also, there is a fear that the sensitivity of the photoreceptor is deteriorated.

When the constituent material of the conductive support is aluminum, a layer containing alumite (alumite layer) may be formed as the undercoat layer.

### (Monolayered Photosensitive Layer 5′)

The monolayered photosensitive layer 5′ contains the charge generation material, the enamine compound represented by the formula (I) as the charge transport material and the binder resin (binding agent) as its major components.

The monolayered photosensitive layer may optionally contain the same additives as those contained in the charge generation layer in such an appropriate amount to the extent that the effect of the present invention is not impaired.

The monolayered photosensitive layer 5′ may be formed by dissolving and/or dispersing the charge generation material, the enamine compound represented by the formula (I) as the charge transport material and optional other additives in a proper organic solvent to prepare a monolayered photosensitive layer coating solution, applying the coating solution on the surface of the conductive support 1 or on the surface of the undercoat layer 2 formed on the conductive support 1, followed by drying to remove the organic solvent.

Other processes and conditions thereof are in accordance with those in the formation of the charge generation layer or the charge transport layer.

The film thickness of the monolayered photosensitive layer is preferably 10 to 100 μm and more preferably 15 to 50 μm, but not be particularly limited thereto. When the film thickness of the monolayered photosensitive layer is less than 10 μm, there is a fear that the charge retention ability of the surface of the photoreceptor is deteriorated, whereas when the film thickness of the monolayered photosensitive layer exceeds 100 μm, there is a fear as to reduced productivity,

### (Protective Layer (Not Shown))

The photoreceptor of the present invention may be provided with a protective layer (not shown) on the multilayered photosensitive layer 5 or on the monolayered photosensitive layer 5′.

The protective layer has a function of improving the abrasive resistance of the photosensitive layer and preventing the chemically adverse influence due to ozone and nitrogen oxides.

The protective layer may be formed, for example, by dissolving or dispersing the binder resin and optional additives such as an antioxidant and ultraviolet absorber in an appropriate organic solvent to prepare a protective layer coating solution and by applying the coating solution on the surface of the monolayered photosensitive layer 5′ or on the surface of the multilayered photosensitive layer 5, followed by drying to remove the organic solvent.

Other processes and conditions thereof are in accordance with those in the formation of the charge generation layer.

The film thickness of the protective layer is preferably 0.5 to 10 μm and more preferably 1 to 5 μm, but not be particularly limited thereto. When the film thickness of the protective layer 5 is less than 0.5 μm, the rubfastness of the surface of the photoreceptor is deteriorated and there is therefore a fear as to unsatisfactory durability, whereas when the film thickness of the protective layer exceeds 10 μm, there is a fear that the resolution of the photoreceptor is deteriorated.

The image forming apparatus of the present invention comprises the electrophotographic photoreceptor according to the present invention, a charging means for charging the electrophotographic photoreceptor, an exposure means for exposing the charged electrophotographic photoreceptor by using a semiconductor laser with an oscillation wavelength of 390 to 500 nm as an exposure light source to form an electrostatic latent image, a developing means for developing the electrostatic latent image formed by the exposure to form a toner image, a transfer means for transfer the developed toner image to a recording material, a fixing means for fixing the transferred toner image to the recording material to form an image, and a cleaning means for removing and recovering a toner left on the electrophotographic photoreceptor.

The image forming apparatus of the present invention will be explained with reference to the drawings, but the present invention is not limited by the following descriptions.

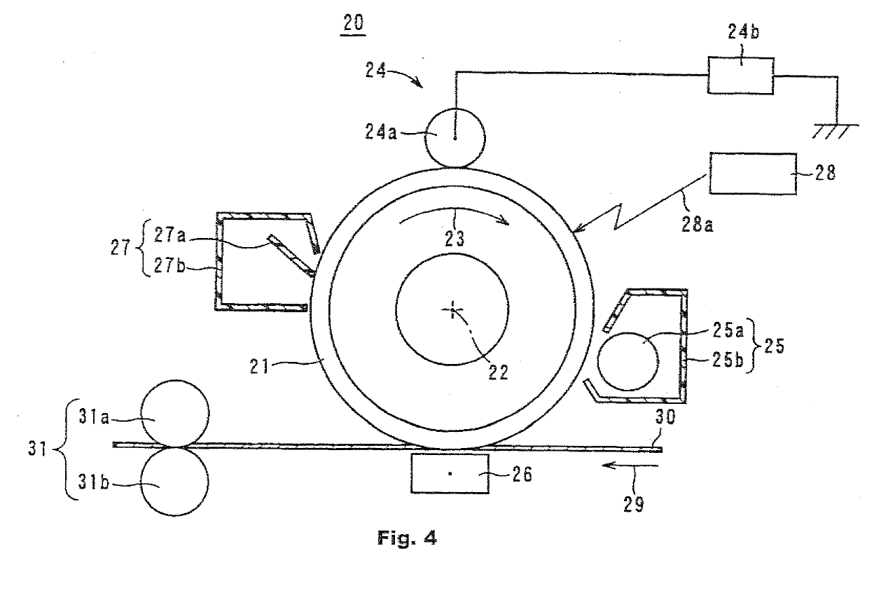

FIG. 4 is a schematic side view showing the structure of the image forming apparatus of the present invention.

An image forming apparatus 20 shown in FIG. 4 has a structure including the photoreceptor 21 of the present invention (for example, any one of the photoreceptor shown in FIGS. 1 to 3), a charging means (charger) 24, an exposure means 28, a developing means (developing unit) 25, a transfer unit 26, a cleaner 27 and a fixing unit 31. The drawing number 30 represents a transfer paper.

The photoreceptor 21 is supported in a rotatable manner by the image forming apparatus 20 body (not shown) and is rotated in the direction of the arrow 23 around a rotation axis 22 by a drive means (not shown). The drive means has, for example, a structure including an electric motor and a reduction gear, and transmits its drive force to the conductive support constituting the core body of the photoreceptor 21 to thereby rotate the photoreceptor 1 at a predetermined peripheral speed. The charger 24, the exposure means 28, the developing unit 25, the transfer unit 26 and the cleaner 27 are disposed in this order towards the downstream side from the upstream side in the direction of the rotation of the photoreceptor 21 as shown by the arrow 23 along the outside peripheral surface of the photoreceptor 21.

The charger 24 is a charging means that charges the outside peripheral surface of the photoreceptor 21 to a predetermined potential, in this embodiment, the charger 24 is realized by a charger wire 24a such as a corotron and scorotron.

As the charging means, a contact type charge roller and a bias power applying voltage to the charge roller may also be used.

The exposure means 28 is provided with, for example, a semiconductor laser as the light source, and applies a light 28a such as a laser beam emitted from the light source, between the charger 24 and the developing unit 25 to expose the outside peripheral surface of the charged photoreceptor 21 depending on image information. The monolayered photoreceptor 21 is scanned repeatedly by the light 28a in the major scanning direction being longitudinal direction of the rotation axis 22 of the photoreceptor 21 to form an electrostatic latent image one by one on the surface of the photoreceptor 21 by this scanning operation.

The developing unit 25 is a developing means that develops the electrostatic latent image formed by exposure on the surface of the photoreceptor 21 by a developer. The developing unit 25 is disposed facing the photoreceptor 21 and provided with a developing roller 25a that supplies a toner to the outside peripheral surface of the photoreceptor 21 and a casing 25b that supports the developing roller 25a in such a manner as to be rotatable around the rotating axis parallel to the rotating axis 22 of the photoreceptor 21 and that receives a developer containing the toner in its inside space.

The transfer unit 26 is a transfer means that transfers the toner image which is a visible image formed on the outside peripheral surface of the photoreceptor 21 by developing, on the transfer paper 30 which is a recording medium supplied between the photoreceptor 21 and the transfer unit 26 from the direction of the arrow 29 by a conveying means (not shown). The transfer unit 26 is, for example, a non-contact type transfer means that is provided with, for example, a charging means and provides charges having inverse polarity with respect to the toner to the transfer paper 30 to thereby transfer the toner image on the transfer paper 30.

The cleaner 27 is a cleaning means that removes and recovers the toner remaining on the outside peripheral surface of the photoreceptor 21 after the transfer operation using the transfer unit 26. The cleaner 27 is provided with a cleaning blade 27a that peels the toner left on the outside peripheral surface of the photoreceptor 21 and a recovery casing 27b receiving the toner peeled by the cleaning blade 27a. This cleaner 27 is disposed together with a discharge lamp (not shown).

The image forming apparatus 20 is also provided with a fixing unit 31 which is a fixing means that fixes the transferred image on the downstream side toward which the transfer paper 30 made to pass between the photoreceptor 21 and the transfer unit 26 is conveyed. The fixing unit 31 is provided with a heating roller 31a provided with a heating means (not shown) and a pressure roller 31b that is disposed facing the heating roller 31a and pressed by the heating roller 31a to form the contact part.

The image formation action of this image forming apparatus 20 is made as follows. First, when the photoreceptor 21 is rotated in the direction of the arrow 23 by a drive means, the surface of the photoreceptor 21 is positively or negatively charged uniformly to a predetermined potential by the charger 24 disposed on the upstream side to the image point of the light 28a from the exposure means 28 in the direction of the rotation of the photoreceptor 21.

Then, the surface of the photoreceptor 21 is irradiated with the light 28a emitted from the exposure means 28 depending on image information. In the photoreceptor 21, the surface charge on the part which is irradiated with the light is removed, which causes a difference in surface potential between the part irradiated with the light 28a and the part not irradiated with the light 28a, resulting in the formation of an electrostatic latent image.

In the present invention, a semiconductor laser with an oscillation wavelength of 390 to 500 nm is used as the exposure light source.

The toner is supplied to the surface of the photoreceptor 21 on which the electrostatic latent image has been formed, from the developing unit 25 disposed on the downstream side to the image point of the light 28a of the exposure means 28 in the direction of the rotation of the photoreceptor 21, to develop the electrostatic latent image, thereby forming a toner image.

The transfer paper 30 is supplied between the photoreceptor 21 and the transfer unit 26 synchronously with the exposure for the photoreceptor 21. Charges having polarity opposite to that of the toner are provided to the supplied transfer paper 30 by the transfer unit 26 to transfer the toner image formed on the surface of the photoreceptor 21 on the surface of the transfer paper 30.

The transfer paper 30 where the toner image has been transferred is conveyed to the fixing unit 31 by a conveying means, and heated and pressurized when it passes through the contact part between the heating roller 31a and pressure roller 31b of the fixing unit 31 to fix the toner image to the transfer paper 30, thereby forming a fast image. The transfer paper 30 on which an image is thus formed is discharged out of the image forming apparatus 20 by the conveying means.

The toner left on the surface of the photoreceptor 21 after the toner image is transferred by the transfer unit 26 is peeled from the surface of the photoreceptor 21 by the cleaner 27 and recovered. The charges on the surface of the photoreceptor 21 from which the toner is removed in this manner are removed by light emitted from a discharge lamp, so that the electrostatic latent image on the surface of the photoreceptor 21 disappears. Thereafter, the photoreceptor 21 is further rotated and driven then, a series of operations beginning with the charging operation are again repeated to form images continuously.

The image forming apparatus of the present invention is provided with the photoreceptor which contains the specific enamine compound, has highly sensitive characteristics at a wavelength range from 390 to 500 nm, is reduced in fatigue caused by light, has high durability, and can therefore form an image having high resolution by exposure using a semiconductor laser with an oscillation wavelength of 390 to 500 nm as the exposure light source.

### EXAMPLES

The present invention will be explained in detail by way of production examples, examples and comparative examples, which are, however, not intended to limit the present invention.

### Production Example 1

### Production of Exemplified Compound 1

1.7 g (1.0 equivalent) of diphenylamine represented by the following structural formula (IV) as a secondary amine compound represented by the formula (II), 2.1 g (1.05 equivalents) of diphenylacetaldehyde represented by the formula (V) as a diphenylacetaldehyde compound represented by the formula (III), and 0.023 g (0.01 equivalents) of DL-10-camphor sulfonic acid were added to 50 mL of toluene in a reactor provided with a Dean-Stark. The mixture was refluxed while heating with an oil bath in a 130° C. to react for 6 hours while removing the water distilled together with toluene.

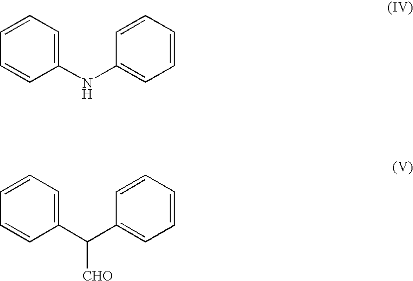

After the reaction was completed, the reaction solution was concentrated until the volume was reduced, to about 1/10, and was gradually added dropwise to 100 mL of hexane with vigorously stirring. Then, the produced crystals were collected by filtration, washed with cooled ethanol and recrystallized from a mixed solvent of ethanol and ethyl acetate to obtain 3.1 g (yield: 84%) of a white powdery compound.

The obtained white powdery compound was analyzed by LC-MS and as a result, a peak corresponding to a molecular ion [M]+ was observed at a molecular weight of 347.3 and also the following fragment peak was observed in a mass spectrum of a main peak corresponding to Exemplified compound 1 (calculated value of molecular weight: 347.17).

MW=270: [M−φ]+>corresponding to the form from which a benzene ring is dissociated>

MW=179: [CH═C(φ)2]+

MW=168: [N(φ)2]+

The obtained white powdery compound was measured by the differential heat conductivity method to quantitatively determine the percentages of carbon (C), hydrogen (H) and nitrogen (N) simultaneously and the results are shown below.

| | |
|---|---|
| Theoretical value | C: 89.88%, H: 6.09%, N: 4.03% |
| Actual value | C: 89.62%, H: 6.26%, N: 4.12% |

It was found from the results that the white powdery compound was Exemplified compound 1 and its purity was 99.5%.

The UV absorption spectrum of the obtained white powdery compound was measured and as a result, it was found that the maximum absorption wavelength was 315 nm and the absorption end was 380 nm.

### Production Examples 2 to 4

### Production of Exemplified Compound Nos. 2, 9 and 16

Exemplified compounds 2, 9 and 16 were produced as in Production Example 1 except that the raw materials shown in Table 1 were used as the secondary amine compound represented by the formula (II) and as the diphenylacetaldehyde compound represented by the formula (III). In Table 1, the value of analysis of the raw material of Exemplified compound 1 and the compounds obtained in Production Examples 1 to 4 are shown together.

TABLE 1

| | Raw materials | | | |
|---|---|---|---|---|
| Compound | Amine | Aldehyde | | |
| Production Example 1 Exemplified compound No. 1 | 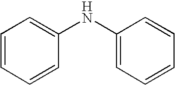 | 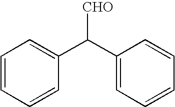 | | |
| Production Example 2 Exemplified compound No. 2 | 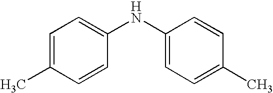 | 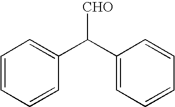 | | |
| Production Example 3 Exemplified compound No. 9 | 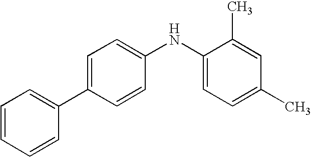 | 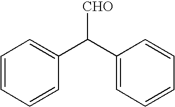 | | |
| Production Example 4 Exemplified compound No. 16 | 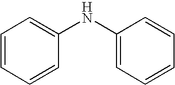 | 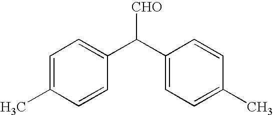 | | |
| | | Elemental analysis | | UV |
| Compound | Structural formula | C(%) H(%) N(%) | LC-MS | (μm) |
| Production Example 1 Exemplified compound No. 1 | 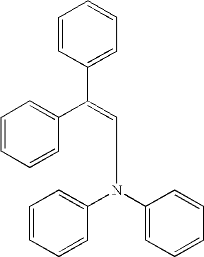 | Theoretical value 8̅9̅.̅8̅8̅ 6̅.̅0̅9̅ 4̅.̅0̅3̅ Actual value 8̅9̅.̅6̅2̅ 6̅.̅2̅6̅ 4̅.̅1̅2̅ | CV 347.2 AV [M]⁺ 347.3 | MAW 315 AE 380 |
| Production Example 2 Exemplified compound No. 2 | 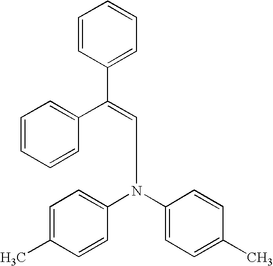 | Theoretical value 8̅9̅.̅5̅6̅ 6̅.̅7̅1̅ 3̅.̅7̅3̅ Actual value 8̅9̅.̅3̅7̅ 6̅.̅9̅5̅ 3̅.̅6̅8̅ | CV 375.2 AV [M]⁺ 375.4 | MAW 327 AE 389 |
| Production Example 3 Exemplified compound No. 9 | 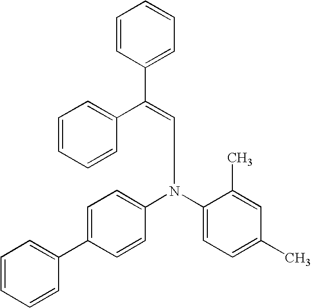 | Theoretical value 9̅0̅.̅4̅3̅ 6̅.̅4̅7̅ 3̅.̅1̅0̅ Actual value 9̅0̅.̅2̅5̅ 6̅.̅7̅0̅ 3̅.̅0̅6̅ | CV 461.2 AV [M]⁺ 461.4 | MAW 332 AE 390 |
| Production Example 4 Exemplified compound No. 16 | 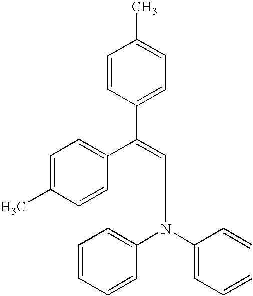 | Theoretical value 8̅9̅.̅8̅6̅ 6̅.̅7̅1̅ 3̅.̅7̅3̅ Actual value 8̅9̅.̅3̅2̅ 8̅.̅8̅8̅ 3̅.̅0̅0̅ | CV 376.2 AV [M]⁺ 375.4 | MAW 330 AE 382 |

CV: Calculated Value
AV: Actual Value
MAW: Maximum Absorption Wavelength
AE: Absorption End

### Example 1

The photoreceptor as shown in FIG. 1 was produced using, as the charge transport material, the enamine compound (Exemplified compound 1) obtained in Production Example 1 according to the present invention.

As the conductive support, one (called “aluminum vapor-deposited PET film”) obtained by vapor-depositing aluminum of 100 nm in thickness on a polyethylene terephthalate (PET) film having a size of 180 mm (length)×250 mm (width)×100 μm (thickness) was used.

7 parts by weight of titanium oxide (trade name: Tipaque TTO55A, produced by Ishihara Sangyo Kaisha Ltd.) and 13 parts by weight of a copolymer nylon resin (trade name: Amilan CM8000, produced by Toray Industries, Inc.) were added in a mixed solvent containing 159 parts by weight of methyl alcohol and 106 parts by weight of 1,3-dioxolan. The mixture was dispersed by a paint shaker for 8 hours to prepare 100 g of an undercoat layer coating solution. The undercoat layer forming solution was applied to the surface of aluminum on the aluminum vapor-deposited PET film being the conductive support by an applicator, followed by naturally dried to form an undercoat layer having a film thickness of 1 μm.

Then, 2 parts by weight of an azo compound represented by the following structural formula (VI) as a charge generation material and 1 part by weight of a butyral resin (trade name: #6000-C, produced by Denki Kagaku Kogyo Kabushiki Kaisha) were added in 98 parts by weight of methyl, ethyl ketone. The mixture was dispersed by a paint shaker for two hours to prepare 50 g of a charge generation layer coating solution. The charge generation layer coating solution was applied to the surface of the undercoat layer formed previously as in the case of the undercoat layer, followed by naturally dried to form a charge generation layer of 0.4 μm in film thickness.

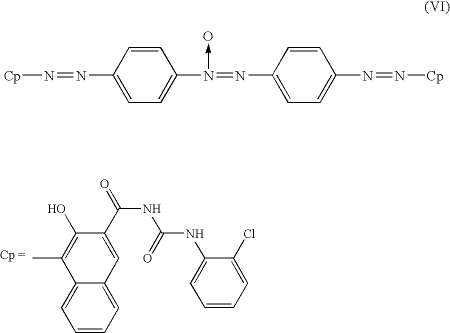

Then, 10 parts by weight of the enamine compound of Exemplified compound 1 as a charge transport material, 18 parts by weight of a polycarbonate resin (trade name: lupilon Z400, produced by Mitsubishi Gas Chemical Company Inc.) and 0.2 parts by weight of 2,6-di-t-butyl-4-methylphenol were dissolved in 140 parts by weight of tetrahydrofuran to prepare 50 g of a charge transport layer coating solution. The charge transport layer coating solution was applied to the surface of the charge generation layer by a baker applicator and naturally dried to form a charge transport layer of 20 μm in film thickness. The photoreceptor shown in FIG. 1 was thus produced.

### Examples 2 to 4

The photoreceptors as shown in FIG. 1 were produced as in Example 1 except that the enamine compounds of Exemplified compounds 2, 9 and 16 as shown in Table 1 were each used in place of Exemplified compound 1.

### Comparative Example 1

The photoreceptor as shown in FIG. 1 was produced as in Example 1 except that a comparative compound (7) represented by the following structural formula (VII) was used in place of Exemplified compound 1.

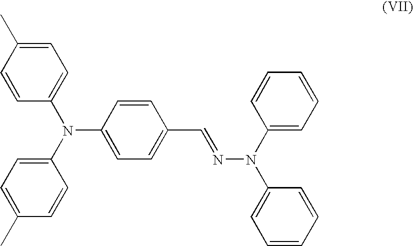

### Comparative Example 2

The photoreceptor as shown in FIG. 1 was produced as in Example 1 except that a comparative compound (8) represented by the following structural formula (VIII) was used in place of Exemplified compound 1.

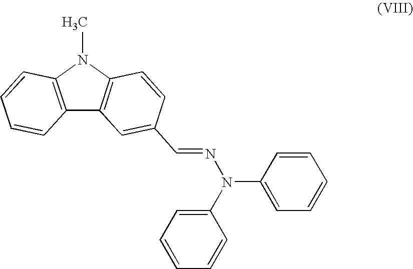

### Example 5

The photoreceptor as shown in FIG. 2 was produced as in Example 1 except that the layer structure of the charge generation layer and the charge transport layer was reversed.

### Example 6

The undercoat layer having a film thickness of 1 μm was formed on the surface of the aluminum vapor-deposited PET film as in Example 1.

Then, 1 parts by weight of the azo compound represented by the structural formula (VI) as a charge generation material, 10 parts by weight of the enamine compound of Exemplified compound 1 as a charge transport material, 4 parts by weight of a polycarbonate resin (trade name: lupilon Z400, produced by Mitsubishi Gas Chemical Company Ltd.), 5 parts by weight of 3-bromo-5,7-dinitrofluorenone and 0.5 parts by weight of 2,6-di-t-butyl-4-methylphenol were mixed in 150 parts by weight of tetrahydrofuran. The mixture was dispersed using a ball mill for 12 hours to prepare 50 g of a monolayered photosensitive layer coating solution. This monolayered photosensitive layer coating solution was applied to the surface of the undercoat layer previously formed, by a baker applicator, and dried at 110° C. for one hour by using hot air to form a charge generation layer of 20 μm in thickness. The photoreceptor as shown in FIG. 3 was thus formed.

### (Evaluation 1)

An electrostatic copy paper tester (trade name: EPA-8200, manufactured by Kawaguchi Electric Works Co., Ltd.) was used to evaluate each photoreceptor produced in Examples 1 to 6 and Comparative Examples 1 and 2 in the following condition. Specifically, evaluation sensitivity E_{1/2} (mJ/cm²) was calculated based on the luminous energy obtained when the surface potential was 300 V at each monochromatic wavelength.

Surface potential of the photoreceptor: −600 V

Exposure wavelength (separated by a monochromater): 450 nm

The residual surface potential Vr (V) at 30 seconds after the exposure was measured.

Further, monochromatic light with a wavelength of 450 nm was used to measure potential variations ΔV₀ and ΔV₁ respectively from the initial sensitivity at the dark potential V₀ (V) (set to 600 V) and the bright potential V₁ (V) (set to 100 V) after charge, exposure and discharge operations were repeated for 1000 times. A negative symbol in potential variation shows a reduction in the absolute value of the potential and a positive symbol in potential variation shows an increase in the absolute value of the potential. It was herein assumed that the photoreceptors of Examples 5 and 6 had plus charged, polarity.

The obtained results are shown in Table 2.

TABLE 2

| | Charge | Charge | Initial properties | | Repetition | |
|---|---|---|---|---|---|---|
| | generation | transport | E_{1/2} | | properties | |
| | material | material | (mJ/cm²) | V₁ (V) | ΔV₀(V) | V₁ (V) |
| Example 1 | Azo | Exemplified | 0.55 | −25 | −18 | 15 |
| | compound | compound 1 | | | | |
| Example 2 | Azo | Exemplified | 0.48 | −23 | −19 | 15 |
| | compound | compound 2 | | | | |
| Example 3 | Azo | Exemplified | 0.4 | −15 | −22 | 18 |
| | compound | compound 9 | | | | |
| Example 4 | Azo | Exemplified | 0.56 | −26 | −15 | 12 |
| | compound | compound 16 | | | | |
| Example 5 | Azo | Exemplified | 0.48 | 18 | −25 | 21 |
| | compound | compound 1 | | | | |
| Example 6 | Azo | Exemplified | 0.4 | 12 | −31 | 25 |
| | compound | compound 1 | | | | |
| Comparative | Azo | Comparative | 3.25 | −265 | −85 | 85 |
| Example 1 | compound | compound (7) | | | | |
| Comparative | Azo | Comparative | 3.75 | −325 | −65 | 98 |
| Example 2 | compound | compound (8) | | | | |

It is found from the results of Table 2 that the photoreceptors of Examples 1 to 6 have higher sensitivity to light with a short wavelength range and more stable repetition properties than the photoreceptors of Comparative Examples 1 and 2.

### Example 7

The photoreceptor as shown in FIG. 1 was produced as in Example 1 except that a thioindigo compound represented by the following formula (IX) in place of the azo compound represented by the structural formula (VI) as the charge generation material.

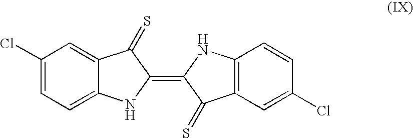

### Examples 8 to 10

The photoreceptors as shown in FIG. 1 were produced as in Example 7 except that the enamine compounds of Exemplified compounds 2, 9 and 16 were each used in place of Exemplified compound 1.

### Comparative Example 3

The photoreceptor as shown in FIG. 1 was produced as in Example 7 except that the comparative compound (7) represented by the structural formula (VII) was used in place of Exemplified compound 1.

### (Evaluation 2)

The photoreceptors produced in Examples 7 to 10 and Comparative Example 3 were evaluated as in Evaluation 1 except that the exposure wavelength was changed to 400 nm, 500 nm and 600 nm. The obtained results are shown in Table 3.

TABLE 3

| | Charge | Charge | Initial properties | | | Repetition | |
|---|---|---|---|---|---|---|---|
| | generation | transport | E_{1/2} (mJ/cm²) | | | properties | |
| | material | material | 400 nm | 500 nm | 600 nm | ΔV₀(V) | V₁ (V) |
| Example 7 | Thioindigo | Exemplified | 1.05 | 1.02 | 1.25 | −15 | 17 |
| | compound | compound 1 | | | | | |
| Example 8 | Thioindigo | Exemplified | 0.99 | 0.97 | 1.22 | −18 | 16 |
| | compound | compound 2 | | | | | |
| Example 9 | Thioindigo | Exemplified | 0.95 | 0.94 | 1.21 | −18 | 20 |
| | compound | compound 9 | | | | | |
| Example 10 | Thioindigo | Exemplified | 1.07 | 1.05 | 1.35 | −14 | 15 |
| | compound | compound 16 | | | | | |
| Comparative | Thioindigo | Comparative | 3.05 | 2.84 | 3.15 | −85 | 102 |
| Example 3 | compound | compound (7) | | | | | |

It is found from the results of Table 3 that the photoreceptors of Examples 7 to 10 have higher sensitivity to light with a short wavelength range and more stable repetition properties than the photoreceptor of Comparative Example 3.

### Example 11

The undercoat layer coating solution prepared as in Example 1 was filled in a coating vessel of a dip coating apparatus. An aluminum conductive support of 0.8 mm (t: thickness)×30 mm (diameter: φ)×326.3 mm (length) was clipped in the solution and then pulled up, followed by naturally dried to form an undercoat layer having a thickness of 1.0 mm.

Then, the charge generation layer coating solution was prepared as in Example 1. and was then applied to the surface of the undercoat layer previously formed, by the same dip coating method as in the case of the undercoat layer, followed, by naturally dried to form a charge generation layer having a thickness of 0.5 nm.

Then, the charge transport layer coating solution was prepared as in Example 1 and was then applied to the surface of the charge generation layer previously formed, by the same dip coating method as in the case of the undercoat layer, followed by dried at 110° C. for one hour to form a charge transport layer having a thickness of 20 nm. The photoreceptor as shown in FIG. 1 was thus produced.

### Comparative Example 4

The photoreceptor as shown in FIG. 1 was produced as in Example 11 except that the comparative compound (8) represented by the structural formula (VIII) was used in place of Exemplified compound 1 in the preparation of the charge transport layer coating solution.

### (Evaluation 3)

With regard to the photoreceptors produced in Example 11 and Comparative Example 4, a one-dot and one-space image corresponding to 1200 dpi and a 5-point character image were output by using a copying machine provided with a semiconductor laser with a short oscillation wavelength (Model: AR-F330, manufactured by Sharp Kabushiki kaisha) and these images were evaluated (reproducibility of dots and characters) according to the following standard.

Reproducibility of dots:
◯: Clear image
×: Disorders of dots occur and vague image

Reproducibility of characters:
◯: Clear image
×: vague character image

The obtained results are shown in Table 4.

TABLE 4

| | Charge transport | Reproducibility | Reproducibility |
|---|---|---|---|
| | material | of dots | of characters |
| Example 11 | Exemplified | ◯ | ◯ |
| | compound 1 | | |
| Comparative | Comparative | X | X |
| Example 4 | compound (8) | | |

It is found from the results of Table 4 that the image forming apparatus provided with the photoreceptor of Example 11 is more superior in reproducibility of dots and characters compared to the image forming apparatus provided with the photoreceptor of Comparative Example 4 and therefore, an output image having high resolution is obtained by the present invention.

### Example 12

The photoreceptor as shown in FIG. 1 was obtained as in Example 11.

### Comparative Example 5

The photoreceptor as shown in FIG. 1 was obtained as in Comparative Example 4.

### (Evaluation 4)

With regard to each photoreceptor produced in Example 12 and Comparative Example 5, an image obtained after 100,000 sheets were printed was evaluated, as in Evaluation 3.

The obtained results are shown in Table 5.

TABLE 5

| | Charge transport | Reproducibility | Reproducibility |
|---|---|---|---|
| | material | of dots | of characters |
| Example 12 | Exemplified | ◯ | ◯ |
| | compound 1 | | |
| Comparative | Comparative | X | X |
| Example 5 | compound (8) | | |

It is found from the results of Table 5 that the image forming apparatus provided with the photoreceptor of Example 12 has higher durability and provides an output image having higher resolution than the image forming apparatus provided with the photoreceptor of Comparative Example 5.

What is claimed is:

1. A electrophotographic photoreceptor comprising a monolayered photosensitive layer containing a charge generation material and a charge transport material or a multilayered photosensitive layer obtained by laying a charge generation layer containing a charge generation material and a charge transport layer containing a charge transport material in this order or in reverse order, on a conductive support, wherein the monolayered photosensitive layer or the charge transport layer of the multilayered photosensitive layer contains, as the charge transport material, an enamine compound represented by the formula (I): 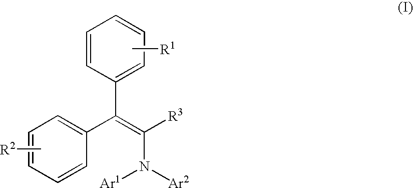
(wherein Ar¹ and Ar², which may be the same or different, respectively represent an aryl group which may have a substituent or a monovalent heterocyclic residue which may have a substituent; R¹ and R², which may be the same or different, respectively represent a hydrogen atom, a halogen atom, an alkyl group which may have a substituent or an alkoxy group which may have a substituent; and R³ represents a hydrogen atom or an alkyl group which may have a substituent), and has photosensitive properties in light of wavelength range from 390 to 500 nm.

2. The electrophotographic photoreceptor of claim 1, wherein Ar¹ and Ar² in the formula (I), which may be the same or different, are respectively an aryl group which may be substituted with a group selected from phenyl, m-tolyl, p-tolyl, 2,4-xylyl, p-cumenyl, 3-trifluoromethylphenyl, 4-methoxyphenyl, 4-fluorophenyl, 2-methyl-4-methoxyphenyl, 4-biphenylyl, 1-naphthyl, 2-naphthyl and pyrenyl.

3. The electrophotographic photoreceptor of claim 1, wherein Ar¹ and Ar² in the formula (I), which may be the same or different, are respectively a monovalent heterocyclic residue which may be substituted, with a group selected from 3-furyl, 2-thienyl, 4-pyridyl, 5-benzofuryl, 5-benzothiophenyl and 5-benzothiazolyl.

4. The electrophotographic photoreceptor of claim 1, wherein R¹ and R² in the formula (I), which may be the same or different, are selected from a hydrogen atom, a fluorine atom, a methyl group, a methoxy group and a trifluoromethyl group.

5. The electrophotographic photoreceptor of claim 1, wherein Ar¹ and Ar² in the formula (I), which may be the same or different, are an aryl group which may have a substituent, R¹ and R², which may be the same or different, are respectively a hydrogen atom or an alkyl group which may have a substituent, and R³ is a hydrogen atom.

6. The electrophotographic photoreceptor of claim 1, wherein the enamine compounds of the formula (I) is selected from
N,N-(diphenyl)-2,2-diphenylvinylamine,
N,N-(di-p-tolyl)-2,2-diphenylvinylamine,
N-(4-biphenylyl)-N-(2,4-xylyl)-2,2-diphenylvinylamine and
N,N-(diphenyl)-2,2-di-p-toylvinylamine.

7. The electrophotographic photoreceptor of claim 1, wherein the monolayered photosensitive layer or the charge transport layer of the multilayered photosensitive layer contains a binder resin, and the ratio E/B of the weight E of the enamine compound to the weight B of the binder resin is 10/12 to 10/25.

8. The electrophotographic photoreceptor of claim 1, wherein the monolayered photosensitive layer or the charge transport layer of the multilayered photosensitive layer contains a binder resin, and the ratio E/B of the weight E of the enamine compound to the weight B of the binder resin is 10/16 to 10/20.

9. The electrophotographic photoreceptor of claim 1, wherein an undercoat layer is provided between the conductive support and the monolayered photosensitive layer or the multilayered photosensitive layer in order to prevent charges from being injected into the monolayered photosensitive layer or the multilayered photosensitive layer from the conductive support and make the surface of the conductive support uniform.

10. The electrophotographic photoreceptor of claim 9, wherein the film thickness of the undercoat layer is 0.01 to 10 μm.

11. An image forming apparatus comprising the electrophotographic photoreceptor of claim 1, a charging means for charging the electrophotographic photoreceptor, an exposure means for exposing the charged electrophotographic photoreceptor by using a semiconductor laser with an oscillation wavelength of 390 to 500 nm as an exposure light source to form an electrostatic latent image, a developing means for developing the electrostatic latent image formed by the exposure to form a toner image, a transfer means for transfer the developed toner image to a recording material, a fixing means for fixing the transferred toner image to the recording material to form an image, and a cleaning means for removing and recovering a toner left on the electrophotographic photoreceptor.
